(19) United States
(12) Patent Application Publication
(10) Pub. No.: US 2026/0348997 A1
(43) Pub. Date: Nov. 5, 2026

(54) Unloading Assembly and Loading Assembly for Sample Processing and/or Analyzing System for Laboratory Automation System

(71) Applicant: ABB Schweiz AG, Baden (CH)

(72) Inventors: Christian Goy, Nidderau (DE); Dirk Walther, Friedberg (DE); Max Novotny, Groß-Zimmern (DE)

(73) Assignee: ABB Schweiz AG, Baden (CH)

(21) Appl. No.: 19/675,715

(22) Filed: May 13, 2026

Related U.S. Application Data
(63) Continuation of application No. PCT/EP2023/083682, filed on Nov. 30, 2023.

(51) Int. Cl. G01N 35/04; G01N 35/00

(52) U.S. Cl. CPC G01N 35/04; G01N 35/0099; G01N 2035/0412; G01N 2035/0465

(57) ABSTRACT

An unloading assembly for automatically unloading a sample tube rack from a sample processing and/or analyzing system of a laboratory automation system includes comprises a removal insert element with a bearing surface inside a first inner volume of the sample processing and/or analyzing system and a removal driving element configured to drive the sample tube rack to move towards a removal position, at which the removal insert element is configured to allow the sample tube rack being removed from the sample processing and/or analyzing system. The invention also relates to a loading assembly for automatically loading a sample tube rack comprising a loading tray with a guide element and a loading driving element, a sample processing and/or analyzing system and a laboratory automation system.

### CROSS-REFERENCE TO RELATED APPLICATIONS

The instant application claims priority to International Patent Application No. PCT/EP2023/083682, filed Nov. 30, 2023, which is incorporated herein in its entirety by reference.

### FIELD OF THE DISCLOSURE

The present disclosure relates to an unloading assembly for automatically unloading a sample tube rack from a sample processing and/or analyzing system of a laboratory automation system.

### BACKGROUND OF THE INVENTION

In a conventional analytical laboratory, biological samples are collected, labelled, pretreated using, for example, a centrifuge and subsequently sorted while preparing for an analytical detection. Typically, the sample preparation may be performed manually by a medical technical assistant. Subsequently, the prepared sample may be loaded into or unloaded from the analyzing device manually and transported between the analyzing device and a sample handling table by the medical technical assistant. A modern automated analysis laboratory equipped is highly desired to be developed with the automation of the pre-detection and post detection procedures.

### BRIEF SUMMARY OF THE INVENTION

The present disclosure relates to an unloading assembly for automatically unloading a sample tube rack from a sample processing and/or analyzing system of a laboratory automation system, a removal insert element for an unloading assembly, a loading assembly for automatically loading a sample tube rack into a sample processing and/or analyzing system of a laboratory automation system, a sample processing and/or analyzing system for a laboratory automation system, the use of an unloading assembly for automatically unloading a sample tube rack from a sample processing and/or analyzing system of a laboratory automation system, the use of a loading assembly for automatically loading a sample tube rack into a sample processing and/or analyzing system of a laboratory automation system, the use of a sample processing and/or analyzing system in a laboratory automation system, a method for automatically operating a laboratory automation system, a computer program, a non-transitory machine readable data carrier and/or a download product with the computer program, and one or more computers and/or compute instances with the computer program and/or with the machine-readable data carrier and/or download product.

It may be seen as an objective of the invention to provide an automated analyzing system with improved sample loading and unloading procedures.

According to a first aspect of the present disclosure, an unloading assembly is provided for a laboratory automation system. The unloading assembly comprises a removal insert element that comprises a bearing surface and a removal driving element. The removal driving element is configured to drive the sample tube rack to move towards a removal position, at which the bearing surface of the removal insert element is in contact with the sample tube rack. The removal insert element is configured to be arranged inside a first inner volume of the sample processing and/or analyzing system and allow the sample tube rack being removed from the sample processing and/or analyzing system at the removal position.

### BRIEF DESCRIPTION OF THE SEVERAL VIEWS OF THE DRAWINGS

Examples of the disclosure will be described in the following with reference to the following drawings.

FIG. 1 shows schematically an example of an unloading assembly of a sample processing and/or analyzing system according to the present disclosure;

FIG. 2 shows schematically an example of an unloading assembly and a loading assembly of a sample processing and/or analyzing system according to the present disclosure;

FIG. 3 shows schematically an example of a sample processing and/or analyzing system comprising an unloading assembly and a loading assembly according to the present disclosure;

FIG. 4 shows schematically an example of a sample processing and/or analyzing system comprising an unloading assembly and a loading assembly according to the present disclosure;

FIG. 5 shows schematically an example of a loading assembly of a sample processing and/or analyzing system according to the present disclosure;

FIG. 6 shows schematically an example of a loading assembly of a sample processing and/or analyzing system according to the present disclosure;

FIG. 7 shows schematically an example of a sample handling system for a sample processing and/or analyzing system according to the present disclosure;

FIG. 8 shows schematically an example of a laboratory automation system according to the present disclosure; and

FIG. 9 shows schematically a flow chart illustrating a method for automatically operating a laboratory automation system according to the present disclosure.

The figures are merely schematic representations and serve only to illustrate examples of the disclosure. Identical or equivalent elements are in principle provided with the same reference signs.

### DETAILED DESCRIPTION OF THE INVENTION

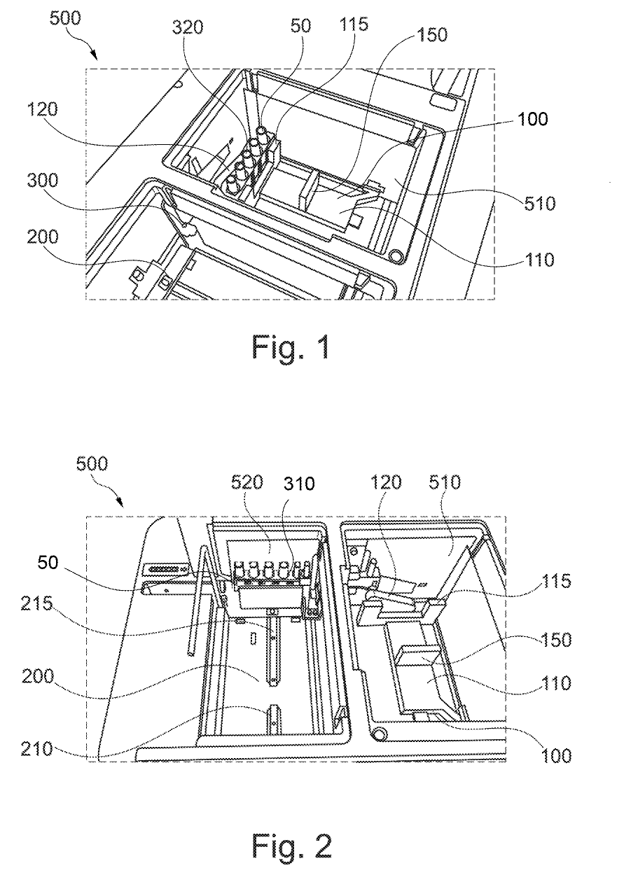

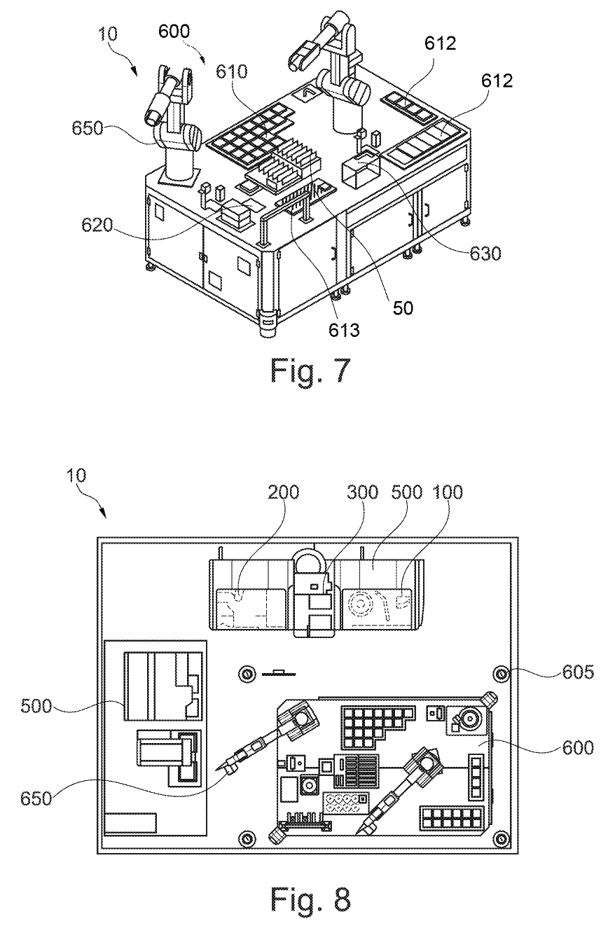

FIGS. 1 - 4 show, respectively, schematically an example of an unloading assembly 100 for automatically unloading a sample tube rack from a sample processing and/or analyzing system 500 of a laboratory automation system 10 (as shown in FIGS. 7 and 8). The unloading assembly 100 comprises a removal insert element 110 and a removal driving element 120.

The unloading assembly 100 may comprise an unloading tray, on which the removal insert element 110 and the removal driving element 120 may be arranged. The unloading assembly, in particular the removal insert element 110, may be arranged inside a first inner volume 510 of the sample processing and/or analyzing system 500.

The removal driving element 120 is arranged inside the first inner volume 510 of the sample processing and/or analyzing system 500 and may be configured to drive the sample tube rack 50 to move from a detection ending position 320 in the sample processing and/or analyzing system 500 towards a removal position, at which the bearing surface of the removal insert element 110 is in contact with the sample tube rack.

The removal insert element 110 comprises a bearing element 115 which comprises a bearing surface, which faces a sample rube rack loaded into the sample processing and/or analyzing system 500. The removal insert element 110 is configured to allow the sample tube rack 50 to be removed from the sample processing and/or analyzing system 500 at the removal position. For example, the removal insert element 110 may be configured to exert a resistance force against the sample tube rack 50 at the bearing surface and to stop the moving of the sample tube rack 50 at the removal position. Optionally, the removal insert element 110 may be fixed inside the first inner volume 510, so that the sample tube rack 50 may be driven to move towards the removal insert element 110, until the sample tube rack 50 comes into contact with the bearing surface at the removal position.

Alternatively, the removal insert element 110 may be configured to be movable between a first position and a second position which may be the removal position, at which the sample tube rack 50 is removable from the sample processing and/or analyzing system 500. Accordingly, the removal insert element 110 may be configured to come into contact with the sample tube rack 50 at the first position, which may be between the detection ending position 320 and the removal position. Further, the removal driving element 120 may be configured to drive the sample tube rack 50 and the removal insert element 110 to move as a whole from the first position to the second removal position.

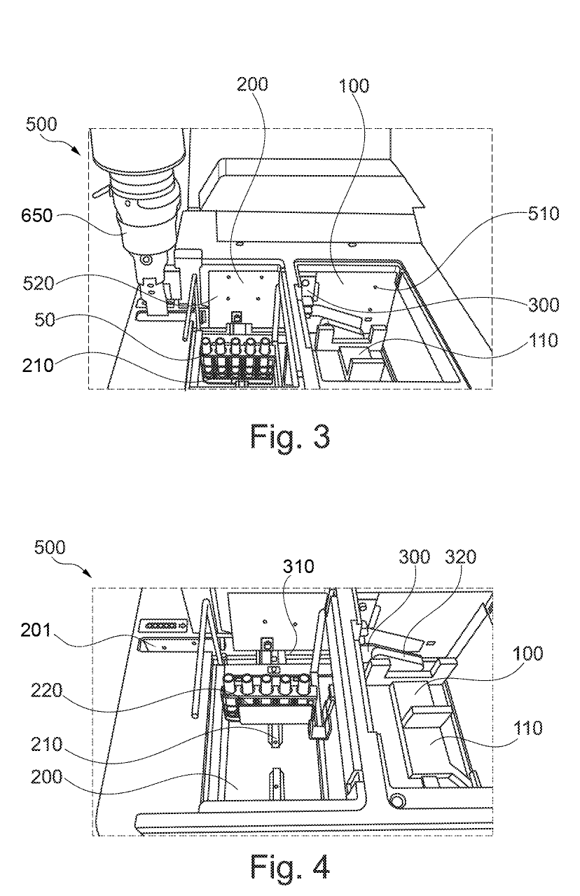

The removal insert element 110 may further comprise a protrusion 150, which may be configured to be driven for moving the removal insert element 110 from the second position to the first position, after the sample tube rack 50 is removed from the sample processing and/or analyzing system 500. As shown in FIG. 1, the protrusion 150 may be designed to extend in parallel to the bearing surface of the bearing element 115. For example, the protrusion 150 may be designed to come into contact with a external robot arm 650 (shown in FIG. 3) at a surface facing away from the detection ending position 320, so that the removal insert element 110 may be driven from the removal position back to the first position, after the sample tube rack 50 is removed from the sample processing and/or analyzing system 500 by the robot arm 650. The unlading assembly 100 may be designed to arrange the removal insert element 110 at the first position, when the sample tube rack 50 is absent in the first inner volume 510.

The removal driving element 120 is arranged at an opposite side of the sample tube rack 50 to the removal insert element 110 and configured to push the sample tube rack 50 and the removal insert element 110 towards the removal position.

The sample tube rack 50 may be a single sample tube rack, which may comprise a plurality of rack openings, such as five rack openings as shown in FIG. 1, for accommodating sample tubes. The removal insert element 110 may be configured to allow the single sample tube rack 50 being removed from the sample processing and/or analyzing system 500 at the removal position, since the removal driving element 120 may be configured to move freely towards the removal insert element 110 in the first inner volume 510 for pushing the single sample tube rack 50 against the removal insert element 110.

The removal insert element 110 may be a three-dimensional printing insert element and designed to fit the first inner volume 510 of the sample processing and/or analyzing system.

FIGS. 1 and 2 show, respectively, that a loading assembly 200 is provided for automatically loading a sample tube rack 50 into a sample processing and/or analyzing system 500 of a laboratory automation system 10.

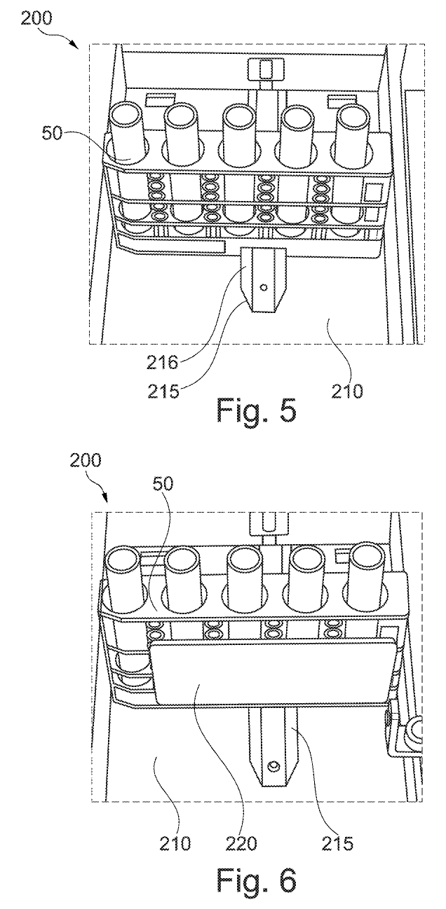

The loading assembly 200 comprises a loading tray 210, which comprises a guide element 215, and a loading driving element 220 as shown in FIGS. 4 and 6, which is configured to exert a driving force on the sample tube rack 50 for loading the sample tube rack 50 for the sample processing and/or analyzing system 500, in particular, for drive the sample tube rack 50 to move from a loading position of the loading assembly 100, as shown in FIG. 5, to a detecting starting position 310 of a detection assembly 300 of the sample processing and/or analyzing system 500. The loading tray 210 may be configured to be arranged inside a second inner volume 520 of the sample processing and/or analyzing system 500 and to allow the loading driving element 220 to drive the sample tube rack 50 to slide along the guide element 215 from the loading position to the detection starting position 310 (shown in FIG. 2). Similar to the unloading assembly 100, the loading assembly 200 may allow the single sample tube rack 50 being arranged on the loading tray 210 and being driven to the detection starting position 310.

As shown in FIGS. 2, 4, 5, and 6, the guide element 215 of the loading tray 210 may be designed to comprise a rail structure which extends along the loading tray 210 and may be configured to allow the sample tube rack 50 sliding along the rail. By means of a robot arm 650 as shown in FIG. 3, the sample tube rack 50 may be placed on the loading tray 210 of the loading assembly 200 in the second inner volume 520.

FIG. 4 shows further that the loading assembly 200 is connected to the detecting assembly 300 at the detection starting position 310, while the unloading assembly 100 is connected to the detecting assembly 300 at the detection ending position 320. The guide element 215 of the loading tray 210 is arranged perpendicular to the detecting path.

Alternatively, or additionally, the loading assembly 200 may be designed as a fast-track channel, which may be configured to allow the sample tube rack 50 moving from the loading tray to the detection starting position 310 continuously without altering the moving direction. The guide element 215 of the loading tray 210 is arranged laterally to the detecting path, allowing the sample tube rack 50 being driven to move from the guide element 215 to the detecting path continuously in a direction.

FIG. 5 shows further that the guide element 215 may comprise a securing unit 216, which may be configured to secure the sample tube rack 50 on the loading tray 210, when the sample tube rack 50 is arranged on the loading tray 210 at the loading position and/or slides along the guide element 215 towards the detection starting position 310. The guide element 215 may be designed to engage with a recess of the sample tube rack 50, which may be arranged at the bottom of the sample tube rack 50.

In FIGS. 2, 4 and 6, the loading driving element 220 is arranged separately from the guide element 215 of the loading tray 210 and may thus be configured to push the sample tube rack 50 towards the detection starting position. Alternatively, the loading driving element 220 may be integrated in the guide element 215 of the loading tray 210 and configured to slide along the guide element 215 with the sample tube rack 50 towards the detection starting position 310, so that an external loading driving element is not necessary, resulting in a simplified and compact loading assembly 100.

FIG. 8 shows schematically an example of a laboratory automation system 10, which comprises multiple sample processing and analyzing systems 500 and a sample handling system 600. The sample processing and analyzing system 500, which is shown in the previous FIGS. 1 - 6, comprises the unloading assembly 100 in the first inner volume 510 with the removal insert element 110 and the removal driving element 120, the loading assembly 200 in the second inner volume 520 with the loading tray 210 having the guide element 215 and the loading driving element 220, and a detecting assembly 300 that may be configured to allow the sample tube rack 50 moving along the detecting path from the detection starting position 310 to the detection ending position 320 to perform the sample detection of the samples accommodating in the sample tube rack 50.

The sample to be detected may be, but not limited to, a biological sample such as a blood sample, a tissue biopsies sample, a saliva sample, a cerebrospinal fluid sample, a sputum sample or a bone marrow sample. For example, the sample processing and analyzing system 500 may be a blood sample analyzing system.

The sample handling system 600 comprises, for example, two robot arms 650 and may be configured to prepare at least one sample in at least one sample tube in the sample tube rack 50. In FIG. 8, one of the two robot arms 650 is arranged at a distance to the sample processing and/or analyzing system 500 and configured to transfer the sample tube rack 50 from the sample handling system 600 to the loading assembly 200 of the sample proceeding and/or analyzing system 500.

The sample processing and analyzing system 500 may further comprise a first sensor, which may be configured to detect a position of the removal insert element 110 of the unloading assembly 100 inside the first inner volume 510. When the position of the removal insert element 110 is detected at the removal position, the one of the robot arms 650 may be activated. As such, the at least one robot arm 650 may be configured to remove the sample tube rack 50 from the sample processing and/or analyzing system 500, when the position of the removal insert element 110 of the unloading assembly 100 is detected at a removal position.

Alternatively, or additionally, the sample processing and analyzing system 500 may further comprise a second sensor, which may be configured to a presence of the sample tube rack 50 at the loading position. The at least one robot arm 650 may be configured to drive the sample tube rack 50 from the loading position to the detection starting position 310 inside the second inner volume 520, when the presence of the sample tube rack 50 is detected at the loading position by means of the second sensor. When the presence of the sample tube rack 50 is not detected at the loading position by means of the second sensor, the robot arm 650 may be configured to arrange the sample tube rack 50 at the loading position in the second inner volume 520.

Alternatively, or additionally, the sample processing and analyzing system 500 may further comprise a third sensor, which may be configured to detect a presence of the sample tube rack 50 at the detection ending position 320. When the sample detection has been accomplished and the presence of the sample tube rack may be detected at the detection ending position 320, the removal driving element 120 of the unloading assembly 100 may be activated to drive the sample tube rack 50 moving out of the detection ending position 320 towards the removal insert element 110 till the removal position. Each of the two robot arms may comprise a gripper, which may be configured to grasp the sample tube rack 50, when arranging the sample tube rack 50 in the second inner volume 520 or when removing the sample tube rack 50 from the first inner volume 510 of the sample processing and/or analyzing system 500.

As shown in FIG. 7, the sample handling system 600 further comprises an operating table 610 having a plurality of regions, the multiple robot arms 650, at least one sample handling device 620 such as a centrifuge, a shaker, an incubator, a mixer for mixing the collected sample with a reagent, or a sample sorting device. Further, as automated and smart sample preparation station, the sample handling system 600 may further comprise a sample identifying device 630 such as a scanning device for identifying and sorting the plurality of samples to be detected, The sample handling system 600 may further comprise a plurality of sample holding units 612, which may be distributed on the operating table 610, and at least one reagent storing unit 613, which may be configured to supply at least one reagent for preparing the at least one sample to be detected for the sample detection.

Using the highly integrated, multi-functional sample handling system 600, it may require a user or a technical assistant to come to replenish one or more reagents in the reagent storing unit 613, for example once a day. The sample detection of the blood samples to be detected may be performed in an automated way without the presence of the medical technical assistant and his manual operation for the rest of the sample preparation workflow. Additionally, the replenishment of the at least one reagent may further be automated, for example, by arranging a fill level sensor in the vicinity of the at least one reagent storing unit. Once the fill level sensor detects that the fill level of the reagent may exceed a fill level minimum, the sample handling system 600 may be configured to replenish the reagent by refilling the reagent storing unit 613 from an external reagent container.

The automated sample handling device 600 may allow an efficient and economic sample analysis or detection even for a small or medium-sized hospital, for example, having up to 350 beds in the hospital, without being affected by the shortage of skilled personnel.

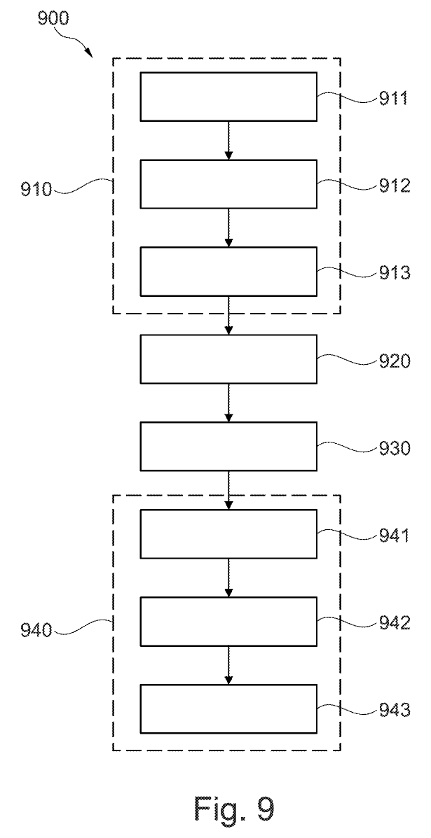

FIG. 9 shows a flow chat illustrating an embodiment of a method 900 for automatically operating a laboratory automation system 10, which comprises the steps for the pre-detection loading process, the detection process, and the post-detection unloading process for a sample processing and/or analyzing system 500.

In the pre-detection loading process, in particular in step 910, the sample tube rack 50 is loaded into the sample processing and/or analyzing system 500 of a laboratory automation system 10 by means of a loading assembly 200. The step 910 comprises the following sub-steps 911, 912, 913.

In step 911, a loading tray 210 of the loading assembly 200 is arranged inside a second inner volume 520 of the sample processing and/or analyzing system 500 at a loading position. In step 913, the sample tube rack 50 is driven to slide along a guide element 215 of the loading tray 210 from the loading position to a detection starting position 310. Optionally, prior to the step 913, in particular between the step 911 and the step 913, the sub step 912 may be provided, in which a presence of the sample tube rack 50 may be detected, by means of a second sensor, at the loading position for loading the sample tube rack 50 into the sample processing and/or analyzing system 500 by means of the at least one robot arm 650.

In the sample detection process, in step 920, the sample tube rack 50 may be allowed to move along a detection path from the detection starting position 310 to the detection ending position 320, followed by the step 930, in which at least one sample is detected in at least one sample tube being arranged in the sample tube rack 50. For example, a plurality of samples in the single sample tube rack 50 may be detected in a sequence, which the single sample tube rack 50 moving along the detection path from the detection starting position 310 to the detection ending position 320.

In the post-detection unloading process, in particular in step 940, the sample tube rack 50 is unloaded from the sample processing and/or analyzing system 500 of the laboratory automation system 10 by means of an unloading assembly 100. The step 940 comprises the following sub-steps 941, 942, 943.

In step 941, a removal insert element 110 of the unloading assembly 100 is arranged, which comprises a bearing surface inside a first inner volume 510 of the sample processing and/or analyzing system 500. In step 942, the sample tube rack 50 is driven to move from a detection ending position 320 towards a removal position by means of a removal driving element 120 of the unloading assembly 100. Optionally, prior to the step 942, a presence of the sample tube rack 50 at the detection ending position may be detected by means of a third sensor, so that the removal driving element 120 may be activated. In step 943, the sample tube rack 50 is removed from the sample processing and/or analyzing system 500 at the removal position by means of at least one robot arm 650. Optionally, the position of the removal insert element 110 of the unloading assembly 100 inside the first inner volume 510 may be detected to determine whether the removal insert element is at the removal position, before the step 943 of the removal of the sample tube rack 50 out of the unloading assembly 100.

The unloading assembly may further comprise an unloading tray, on which the removal insert element and the removal driving element may be arranged. The removal insert element may comprise a bearing element, which comprise the bearing surface facing the sample tube rack to be removed. At the removal position, the removal insert element may be configured to exert a resistance force against the sample tube rack at the bearing surface. In other words, the removal insert element may be configured to stop the moving of the sample tube rack driven by the removal driving element, so that the sample tube rack may be removed from the unloading assembly and from the sample processing and/or analyzing system, for example, by means of a robot arm. In this way, the unloading procedure for the sample detection in the sample processing and/or analyzing system may be automated, without a manual loading by a user or a technical assistant. Advantageously, the automated unloading assembly may allow an efficient and economic sample analysis or detection even for a small or medium-sized hospital, for example, having up to 350 beds in the hospital, without being affected by the shortage of skilled personnel.

According to an embodiment, the sample tube rack may be a single sample tube rack comprising at least one rack opening for accommodating at least one sample tube. The removal insert element may be configured to allow the single sample tube rack to be removed from the sample processing and/or analyzing system at the removal position.

According to another embodiment, the removal insert element may be configured to be movable between a first position and a second position being the removal position, at which the sample tube rack is removable from the sample processing and/or analyzing system.

According to another embodiment, the removal insert element may be configured to come into contact with the sample tube rack at the first position. The removal driving element may be configured to drive the sample tube rack and the removal insert element to move from the first position to the second position for removing the sample tube rack.

According to another embodiment, the removal insert element may further comprise a protrusion, which may be configured to be driven for moving the removal insert element from the second position to the first position, after the sample tube rack may be removed from the sample processing and/or analyzing system.

According to another embodiment, the removal driving element may be configured to be arranged inside the first inner volume of the sample processing and/or analyzing system. The removal driving element may be arranged at an opposite side of the sample tube rack to the removal insert element and configured to push the sample tube rack and the removal insert element towards the removal position.

According to another embodiment, the removal driving element may be arranged at the same side of the sample tube rack as the removal insert element and configured to pull the sample tube rack and the removal insert element towards the removal position.

For example, the removal driving element may be a suction element that may be arranged directly on the removal insert element to pull the sample tube rack for the removal of the sample tube rack. The removal driving element may be integrated at the bearing surface of the removal insert element. In this way, a separately arranged driving element may not be provided in the sample processing and/or analyzing system. The unloading assembly may thus comprise a compact and simplified structure.

According to a second aspect, a removal insert element is provided for an unloading assembly for automatically unloading a sample tube rack from a sample processing and/or analyzing system of a laboratory automation system. The removal insert element comprises a bearing surface, which is configured to stop the sample tube sack moving at the removal position and to allow the sample tube rack that is removed from the sample processing and/or analyzing system at the removal position.

According to an embodiment, the removal insert element may be a three-dimensional printing insert element and designed to be arranged inside a first inner volume of the sample processing and/or analyzing system.

According to a third aspect, a loading assembly is provided for automatically loading a sample tube rack into a sample processing and/or analyzing system of a laboratory automation system. The loading assembly comprises a loading tray, which comprises a guide element, and a loading driving element, which is configured to exert a driving force on the sample tube rack for loading the sample tube rack for the sample processing and/or analyzing system. The loading tray is configured to be arranged inside a second inner volume of the sample processing and/or analyzing system and to allow the loading driving element to drive the sample tube rack to slide along the guide element from a loading position to a detection starting position.

According to an embodiment, the sample tube rack may be a single sample tube rack which may comprise at least one rack opening for accommodating at least one sample tube. The loading tray may be configured to allow the single sample tube rack to be arranged on the loading tray and being driven to the detection starting position.

According to another embodiment, the guide element may be designed to be a rail that may extend along the loading tray and configured to allow the sample tube rack sliding along the rail.

According to another embodiment, the guide element of the loading tray may comprise a securing unit, which may be configured to secure the sample tube rack on the loading tray, when the sample tube rack is arranged on the loading tray at the loading position and/or slides along the guide element towards the detection starting position.

According to another embodiment, the guide element may be designed to engage with a recess of the sample tube rack, which may be arranged at the bottom of the sample tube rack.

According to another embodiment, the loading driving element of the loading assembly may be arranged separately from the guide element 215 of the loading tray 210 and configured to push the sample tube rack towards the detection starting position.

According to another embodiment, the loading driving element may be integrated in the guide element of the loading tray and configured to slide along the guide element with the sample tube rack towards the detection starting position.

According to another aspect, a sample processing and/or analyzing system is provided for a laboratory automation system, which comprises an unloading assembly, a loading assembly and a detecting assembly. The unloading assembly is arranged in a first inner volume of the sample processing and/or analyzing system and comprises a removal insert element and a removal driving element. The loading assembly is arranged in a second inner volume of the sample processing and/or analyzing system and comprises a loading tray that comprises a guide element and a loading driving element. The detecting assembly is configured to allow a sample tube rack that moves along a detection path from a detection starting position to a detection ending position for detecting at least one sample in at least one sample tube that is arranged in the sample tube rack.

The loading assembly is configured to allow the sample tube rack being loaded on the loading tray inside the second inner volume and to allow the sample tube rack being driven to move from a loading position to the detection starting position of the detecting assembly by means of the guide element and the loading driving element.

The unloading assembly is configured to allow the sample tube rack being driven to move from the detection ending position of the detecting assembly to a removal position inside the first inner volume by means of the removal insert element and the removal driving element.

According to an embodiment, the loading assembly may be connected to the detecting assembly at the detection starting position. The unloading assembly may be connected to the detecting assembly at the detection ending position.

According to another embodiment, the guide element of the loading tray may be arranged perpendicular to the detecting path. Alternatively, or additionally, the guide element of the loading tray may be arranged laterally to the detecting path, allowing the sample tube rack being driven to move from the guide element to the detecting path continuously in a direction.

For example, the second inner volume may be arranged next to the first inner volume in the sample processing and/or analyzing system. The second inner volume may be designed to allow the sample tube rack, which may comprise an elongated shape, being arranged parallel to the detecting path of the detecting assembly and moving towards the detection starting position in a direction perpendicular to the detecting path of the detecting assembly.

Alternatively, or additionally, the second inner volume may be designed as a fast-track channel. The second inner volume may be designed to allow the sample tube rack to move from the loading tray to the detection starting position without altering the moving direction.

According to another embodiment, the sample processing and/or analyzing system may further comprise a first sensor, which may be configured to detect a position of the removal insert element of the unloading assembly inside the first inner volume, and a second sensor, which may be configured to detect a presence of the sample tube rack at the loading position.

For example, when the position of the removal insert element may be detected to be at the removal position by means of the first sensor, the sample tube rack may be removed from the sample processing and/or analyzing system, for example, by means of a robot arm.

For example, when the presence of the sample tube rack may be detected at the loading position by means of the second sensor, the loading assembly may be configured to actuate the loading driving element to move towards the sample tube rack and drive the sample tube rack to slide along the guide element of the loading tray.

The first sensor and the second sensor may advantageously result in an automated sample processing and/or analyzing system. Alternatively, or additionally, the sample processing and/or analyzing system may further comprise a third sensor, configured to detect a presence of the sample tube rack at the detection ending position. When the sample detection has been accomplished and the presence of the sample tube rack may be detected to be at the detection ending position, the removal driving element of the unloading assembly may be activated to drive the sample tube rack moving out of the detection ending position and towards the removal insert element till the removal position.

According to another aspect, a laboratory automation system is provided, which comprises a sample processing and/or analyzing system and a sample handling system that comprises at least one robot arm and is configured to prepare at least one sample in at least one sample tube in the sample tube rack. The sample processing and/or analyzing system comprises an unloading assembly, which is arranged in a first inner volume of the sample processing and/or analyzing system and comprises a removal insert element and a removal driving element, a loading assembly, which is arranged in a second inner volume of the sample processing and/or analyzing system and comprises a loading tray having a guide element and a loading driving element, and a first sensor, which is configured to detect a position of the removal insert element of the unloading assembly inside the first inner volume, and/or a second sensor, which is configured to detect a presence of the sample tube rack on the loading tray at the loading position.

The at least one robot arm is arranged at a distance to the sample processing and/or analyzing system and configured to transfer the sample tube rack from the sample handling system to the loading assembly of the sample proceeding and/or analyzing system. Further, the at least one robot arm is configured to remove the sample tube rack from the sample processing and/or analyzing system, when a position of the removal insert element of the unloading assembly is detected at a removal position inside the first inner volume by the means of the first sensor. Alternatively, or additionally, the at least one robot arm is configured to drive the sample tube rack from a loading position to a detection starting position inside the second inner volume, when a presence of the sample tube rack is detected at the loading position inside the second inner volume by means of the second sensor.

According to an embodiment, the at least one robot arm may be configured to arrange the sample tube rack at the loading position in the second inner volume of the sample processing and/or analyzing system, when the presence of the sample tube rack is not detected at the loading position by means of the second sensor.

According to another embodiment, the at least one robot arm may comprise a gripper, which may be configured to grasp the sample tube rack, when arranging the sample tube rack in the second inner volume of the sample processing and/or analyzing system or when removing the sample tube rack from the first inner volume of the sample processing and/or analyzing system.

According to another embodiment, the at least one robot arm may comprise a first robot arm and a second robot arm. The laboratory automation system may be configured to alternatively actuate the first robot arm and the second robot arm for arranging the sample tube rack in the second inner volume of the sample processing and/or analyzing system or for removing the sample tube rack from the first inner volume of the sample processing and/or analyzing system.

According to another aspect, the use of an unloading assembly of the present disclosure is provided for automatically unloading a sample tube rack from a sample processing and/or analyzing system of a laboratory automation system.

According to another aspect, the use of a loading assembly of the present disclosure for automatically loading a sample tube rack into a sample processing and/or analyzing system of a laboratory automation system.

According to another aspect, the use of a sample processing and/or analyzing system of the present disclosure in a laboratory automation system.

According to another aspect, a method is provided for automatically operating a laboratory automation system. The method comprises the following step of unloading a sample tube rack from a sample processing and/or analyzing system of the laboratory automation system by means of an unloading assembly, which comprises the following sub-steps of: arranging a removal insert element of the unloading assembly that comprises a bearing surface inside a first inner volume of the sample processing and/or analyzing system; driving the sample tube rack to move from a detection ending position towards a removal position by means of a removal driving element of the unloading assembly; removing the sample tube rack from the sample processing and/or analyzing system at the removal position by means of at least one robot arm.

According to an embodiment, the method may further comprise the step of loading the sample tube rack into the sample processing and/or analyzing system of a laboratory automation system by means of a loading assembly, which comprises the following sub-steps of: arranging a loading tray of the loading system inside a second inner volume of the sample processing and/or analyzing system at a loading position; driving the sample tube rack to slide along a guide element of the loading tray from the loading position to a detection starting position.

According to another embodiment, the method may further comprise the step of detecting, by means of a second sensor, a presence of the sample tube rack at the loading position for loading the sample tube rack into the sample processing and/or analyzing system by means of the at least one robot arm, before the driving the sample tube rack slide along the guide element of the loading tray from the loading position to the detection starting position.

Additionally, in order to perform the sample detection, the method may further comprise the step of allowing the sample tube rack moving along a detection path from the detection starting position to the detection ending position, and the step of detecting at least one sample in at least one sample tube being arranged in the sample tube rack, before the unloading the sample tube rack from the sample processing and/or analyzing system of the laboratory automation system by means of the unloading assembly.

According to another aspect, there is provided a computer program that comprises machine-readable instructions that, when executed by one or more computers and/or compute instances, cause the one or more computers and/or compute instances to perform a method for automatically operating a laboratory automation system.

According to another aspect, there is provided a non-transitory machine-readable data carrier and/or a download product with the computer program. A download product is an instance of the computer program that may be sold and downloaded online for immediate fulfilment in lieu of physically shipping a machine-readable data carrier.

According to another aspect, there are provided one or more computers and/or compute instances with the computer program comprising machine-readable instructions that, when executed by one or more computers and/or compute instances, cause the one or more computers and/or compute instances to perform a method for automatically operating a laboratory automation system, and/or with the machine-readable data carrier and/or download product with the computer program.

The method may be at least partly computer-implemented, and may be implemented in software or in hardware, or in software and hardware. Further, the method may be carried out by computer program instructions running on means that provide data processing functions. The data processing means may be a suitable computing means, such as an electronic control module etc., which may also be a distributed computer system. The data processing means or the computer, respectively, may comprise one or more of a processor, a memory, a data interface, or the like.

It should be noted that the above examples may be combined with each other irrespective of the aspect involved. Accordingly, the method may be combined with structural features and, likewise, the apparatus and the system may be combined with features described above with regard to the method.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### LIST OF REFERENCE SIGNS

10 laboratory automation system

50 sample tube rack

100 unloading assembly

110 removal insert element

115 bearing element

120 removal driving element

150 protrusion

200 loading assembly

201 fast track loading channel

210 loading tray

215 guide element

216 securing unit

220 loading driving element

300 detecting assembly

300 detecting assembly

320 detection ending position

500 sample processing and/or analyzing system

510 first inner volume

520 second inner volume

600 sample handling system

605 emergency stop button

610 operating table

612 sample holding unit

613 reagent storing unit

620 sample handling device

630 sample identifying device

650 robot arm

900 method for automatically operating a laboratory automation system

910 loading sample tube rack into sample processing and/or analyzing system of laboratory automation system

911 arranging loading tray of the loading system inside second inner volume of sample processing and/or analyzing system at loading position

912 detecting, by means of second sensor, presence of sample tube rack at loading position

913 driving sample tube rack to slide along guide element of the loading tray from loading position to detection starting position

920 allowing sample tube rack moving along detection path from detection starting position to detection ending position

930 detecting sample in sample tube in sample tube rack

940 unloading sample tube rack from sample processing and/or analyzing system of laboratory automation system

941 arranging removal insert element of unloading assembly inside first inner volume

942 driving sample tube rack to move from detection ending position towards removal position

943 removing sample tube rack from sample processing and/or analyzing system at removal position

What is claimed is:

1. An unloading assembly for automatically unloading a sample tube rack from a sample processing and/or analyzing system of a laboratory automation system, comprising:
a removal insert element comprising a bearing surface;
a removal driving element;
wherein the removal driving element is configured to drive the sample tube rack to move towards a removal position, at which the bearing surface of the removal insert element is in contact with the sample tube rack;
wherein the removal insert element is configured to be arranged inside a first inner volume of the sample processing and/or analyzing system and allow the sample tube rack being removed from the sample processing and/or analyzing system at the removal position.

2. The unloading assembly according to claim 1, wherein the sample tube rack is a single sample tube rack comprising at least one rack opening for accommodating at least one sample tube; and wherein the removal insert element is configured to allow the single sample tube rack being removed from the sample processing and/or analyzing system at the removal position.

3. The unloading assembly according to claim 1, wherein the removal insert element is configured to be movable between a first position and a second position being the removal position, at which the sample tube rack is removable from the sample processing and/or analyzing system.

4. The unloading assembly according to claim 3, wherein the removal insert element is configured to come into contact with the sample tube rack at the first position; and wherein the removal driving element is configured to drive the sample tube rack and the removal insert element to move from the first position to the second position for removing the sample tube rack.

5. The unloading assembly according to claim 4, wherein the removal insert element further comprises a protrusion configured to be driven for moving the removal insert element from the second position to the first position after the sample tube rack is removed from the sample processing and/or analyzing system.

6. The unloading assembly according to claim 1, wherein the removal driving element is configured to be arranged inside the first inner volume of the sample processing and/or analyzing system; and wherein the removal driving element is arranged at an opposite side of the sample tube rack to the removal insert element and configured to push the sample tube rack and the removal insert element towards the removal position.

7. The unloading assembly according to claim 1, wherein the removal driving element is arranged at the same side of the sample tube rack as the removal insert element and configured to pull the sample tube rack and the removal insert element towards the removal position.

8. The unloading assembly according to claim 1, further comprising a removal insert element comprising a bearing surface configured to stop the sample tube rack moving at the removal position and to allow the sample tube rack being removed from the sample processing and/or analyzing system at the removal position.

9. The unloading assembly according to claim 8, wherein the removal insert element further includes a protrusion configured to be driven for moving the removal insert element from a second position being the removable position to a first position, after the sample tube rack is removed from the sample processing and/or analyzing system.

10. The unloading assembly according to claim 8, wherein the removal insert element is a three-dimensional printing insert element and configured to be arranged inside a first inner volume of the sample processing and/or analyzing system.

11. A loading assembly for automatically loading a sample tube rack into a sample processing and/or analyzing system of a laboratory automation system, comprising:
a loading tray comprising a guide element; and
a loading driving element configured to exert a driving force on the sample tube rack for loading the sample tube rack for the sample processing and/or analyzing system;
wherein the loading tray is configured to be arranged inside a second inner volume of the sample processing and/or analyzing system and to allow the loading driving element to drive the sample tube rack to slide along the guide element from a loading position to a detection starting position.

12. The loading assembly according to claim 11, wherein the sample tube rack is a single sample tube rack comprising at least one rack opening for accommodating at least one sample tube; and wherein the loading tray is configured to allow the single sample tube rack being arranged on the loading tray and being driven to the detection starting position.

13. The loading assembly according to claim 11, wherein the guide element is designed to be a rail extending along the loading tray and configured to allow the sample tube rack sliding along the rail.

14. The loading assembly according to claim 13, wherein the guide element of the loading tray comprises a securing unit configured to secure the sample tube rack on the loading tray when the sample tube rack is arranged on the loading tray at the loading position and/or slides along the guide element towards the detection starting position.

15. The loading assembly according to claim 14, wherein the guide element is designed to engage with a recess of the sample tube rack, which is arranged at the bottom of the sample tube rack.

16. The loading assembly according to claim 11, wherein the loading driving element is arranged separately from the guide element of the loading tray and configured to push the sample tube rack towards the detection starting position.

17. The loading assembly according to claim 11, wherein the loading driving element is integrated in the guide element of the loading tray and configured to slide along the guide element with the sample tube rack towards the detection starting position.

18. A sample processing and/or analyzing system for a laboratory automation system, comprising:
an unloading assembly for automatically unloading a sample tube rack from the sample processing and/or analyzing system of a laboratory automation system, the unloading assembly comprising:
a removal insert element comprising a bearing surface;
a removal driving element;
wherein the removal driving element is configured to drive the sample tube rack to move towards a removal position, at which the bearing surface of the removal insert element is in contact with the sample tube rack;
wherein the removal insert element allows the sample tube rack being removed from the sample processing and/or analyzing system at the removal position;
wherein the unloading assembly is arranged in a first inner volume of the sample processing and/or analyzing system and includes a removal insert element and a removal driving element;
a loading assembly for automatically loading the sample tube rack into the sample processing and/or analyzing system of a laboratory automation system, comprising:
a loading tray comprising a guide element; and
a loading driving element configured to exert a driving force on the sample tube rack for loading the sample tube rack for the sample processing and/or analyzing system;
wherein the loading tray allows the loading driving element to drive the sample tube rack to slide along the guide element from a loading position to a detection starting position;
wherein the loading assembly is arranged in a second inner volume of the sample processing and/or analyzing system and includes a loading tray comprising a guide element and a loading driving element; and
a detecting assembly configured to allow a sample tube rack moving along a detecting path from a detection starting position to a detection ending position for detecting at least one sample in at least one sample tube being arranged in the sample tube rack;
wherein the loading assembly is configured to allow the sample tube rack being loaded on the loading tray inside the second inner volume and to allow the sample tube rack being driven to move from a loading position to the detection starting position of the detecting assembly using the guide element and the loading driving element; and
wherein the unloading assembly is configured to allow the sample tube rack being driven to move from the detection ending position of the detecting assembly to a removal position inside the first inner volume using the removal insert element and the removal driving element.

19. The sample processing and/or analyzing system according to claim 18, wherein the loading assembly is connected to the detecting assembly at the detection starting position; wherein the unloading assembly is connected to the detecting assembly at the detection ending position.

20. The sample processing and/or analyzing system according to claim 18, wherein the guide element of the loading tray is arranged perpendicular to the detecting path; and/or wherein the guide element of the loading tray is arranged laterally to the detecting path, allowing the sample tube rack being driven to move from the guide element to the detecting path continuously in a direction.

21. The sample processing and/or analyzing system according to claim 18, further comprising a first sensor configured to detect a position of the removal insert element of the unloading assembly inside the first inner volume, and/or a second sensor configured to detect a presence of the sample tube rack at the loading position.

22. A laboratory automation system, comprising:
a sample processing and/or analyzing system that includes an unloading assembly arranged in a first inner volume of the sample processing and/or analyzing system and comprising a removal insert element and a removal driving element;
a loading assembly arranged in a second inner volume of the sample processing and/or analyzing system and comprising a loading tray comprising a guide element and a loading driving element;
a first sensor configured to detect a position of the removal insert element of the unloading assembly inside the first inner volume and/or a second sensor configured to detect a presence of the sample tube rack at the loading position;
a sample handling system comprising at least one robot arm and configured to prepare at least one sample in at least one sample tube in the sample tube rack;
wherein the at least one robot arm is arranged at a distance to the sample proceeding and/or analyzing system and configured to transfer the sample tube rack from the sample handling system to the loading assembly of the sample proceeding and/or analyzing system;
wherein the at least one robot arm is configured to remove the sample tube rack from the sample processing and/or analyzing system, when a position of the removal insert element of the unloading assembly is detected at a removal position inside the first inner volume using the first sensor; and/or
wherein the at least one robot arm is configured to drive the sample tube rack from a loading position to a detection starting position inside the second inner volume when a presence of the sample tube rack is detected at a loading position inside the second inner volume using the second sensor.

23. The laboratory automation system according to claim 22, wherein the at least one robot arm is configured to arrange the sample tube rack at the loading position in the second inner volume of the sample processing and/or analyzing system, when the presence of the sample tube rack is not detected at the loading position by means of the second sensor.

24. The laboratory automation system according to claim 22, wherein the at least one robot arm comprises a gripper configured to grasp the sample tube rack when arranging the sample tube rack in the second inner volume of the sample processing and/or analyzing system or when removing the sample tube rack from the first inner volume of the sample processing and/or analyzing system.

25. The laboratory automation system according to claim 22, wherein the at least one robot arm comprises a first robot arm and a second robot arm; and wherein the laboratory automation system is configured to alternatively actuate the first robot arm and the second robot arm for arranging the sample tube rack in the second inner volume of the sample processing and/or analyzing system, or for removing the sample tube rack from the first inner volume of the sample processing and/or analyzing system.

26. A method for automatically operating a laboratory automation system, comprising:
unloading a sample tube rack from a sample processing and/or analyzing system of the laboratory automation system using an unloading assembly;
arranging a removal insert element of the unloading assembly comprising a bearing surface inside a first inner volume of the sample processing and/or analyzing system;
driving the sample tube rack to move from a detection ending position towards a removal position using a removal driving element of the unloading assembly;
removing the sample tube rack from the sample processing and/or analyzing system at the removal position by means of at least one robot arm.

27. The method according to claim 26, further comprising loading the sample tube rack into the sample processing and/or analyzing system of a laboratory automation system using a loading assembly, by:
arranging a loading tray of the loading assembly inside a second inner volume of the sample processing and/or analyzing system at a loading position; and
driving the sample tube rack to slide along a guide element of the loading tray from the loading position to a detection starting position.

28. The method according to claim 26, further comprising:
detecting, using a second sensor, a presence of the sample tube rack at the loading position for loading the sample tube rack into the sample processing and/or analyzing system using the at least one robot arm before the driving the sample tube rack to slide along the guide element of the loading tray from the loading position to the detection starting position;
allowing the sample tube rack to move along a detection path from the detection starting position to the detection ending position; and
detecting at least one sample in at least one sample tube being arranged in the sample tube rack before unloading the sample tube rack from the sample processing and/or analyzing system of the laboratory automation system by means of the unloading assembly.
